(19) United States
(12) Patent Application Publication
(10) Pub. No.: US 2015/0007703 A1
(43) Pub. Date: Jan. 8, 2015

(54) Multiple insert fence system

(71) Applicant: Robert Emanuel Maraventano, Ronkonkoma, NY (US)

(72) Inventor: Robert Emanuel Maraventano, Ronkonkoma, NY (US)

(21) Appl. No.: 13/999,793

(22) Filed: Mar. 22, 2014

Related U.S. Application Data
(60) Provisional application No. 61/852,962, filed on Mar. 25, 2013.

(51) Int. Cl. B23D 45/04; B23D 47/04

(52) U.S. Cl. CPC B23D 45/04; B23D 47/04
USPC 83/468.3

(57) ABSTRACT

An auxiliary fence system which mounts on a mitre saw, for accommodating the cutting of material at each selectively of the various angles available on the mitre saw. There is provided a longitudinally extending stationary fence-frame having a generally L-shaped cross-section. The fence-frame overlays a stock table, and vertical back-fence of the mitre saw. Bolts secure the fence-frame to the stock vertical back-fence utilizing through-holes with counter-bores disposed along a vertical back-fence portion of the fence-frame. These through-holes having counter-bores, locationally correspond with through-holes disposed along the stock vertical back-fence of the mitre saw. The fence-frame further includes an aperture, being generally centered about a blade of the mitre saw. The fence system includes multiple angle-dedicated inserts, each selectively of which operatively engage and removably secure within the aperture. There are then formed smooth, continuous surfaces, in the horizontal, and vertical planes, against which material to be cut is placed, and supported. In operation, a blades-width partial kerf-cut is sustained within each selectively of the angle-dedicated inserts. This partial cut thereafter delineates a precise and reusable cutting-reference for a selected angle.

### BACKGROUND

1. Field of Invention

The invention relates generally to powered cutting tools of the type having a circular cutting blade as their respective cutting element, and more specifically to an auxiliary fence system which overlays the body of a stock mitre saw.

2. Discussion of Prior-Art

Powered cutting tools of the type having a circular cutting-blade employ one or more of integral or stock, and or end-user installed auxiliary fence(s). These fences are of varied configuration and intended purpose. One essential purpose is provision of rigid physical structure against which a workpiece is placed. This offers support or back-up to material being cut. As herein interchangably referred to, material being cut is a workpiece, and exemplary shorter off-cut sections result from cutting operations which sever workpieces.

As different available blade dispositions including height, angle or mitre, bevel and combinations thereof are set and utilized, a cutting-range develops within which cuts are made. As herein described, a cutting-area extends somewhat into areas adjacent to, and inclusive of the cutting-range itself. It is throughout this cutting-area that a workpeice most necessarily needs to be backed-up. As relates most specifically to mitre saws, relatively large clearance gaps are provided facilitating that a blade being set in any available position will not damage any portion(s) of the saw itself.

Distinct disadvantages result from having a gap overly large in relation to a generally ⅛″ thick saw blade. One disadvantage, dangerous in nature is evident when shorter sections of off-cut material result from a given cutting operation. Often after a workpiece is severed a shorter off-cut section, having not sufficient back-up is pulled by the still spinning blade, smashes up within a blade housing and is uncontrollably thrown. It has been known too, that a short off-cut will sometimes become unintentionally lodged within a blade housing to be indiscriminately shot out during a successive cut.

A further disadvantage of having overly large gaps pertains to quality of cut. As cuts are made and the blade exits the workpiece, solid wood fibres tend to tear-out, and in composite wood products, chipping occurs. On a typically square or rectangular workpiece, there are two planes or surfaces subject to tear-out and chipping. These surfaces are the back, and bottom of a workpiece where the blade exits, completing a cut.

Difficulty in positioning a workpiece so as to be cut to a desired length also arises, owing to an overly large gap. This is because an operator hasn't clear reference as to precisely where a blade will cut. In practice a cutting-mark on a workpiece, indicating the desired length, must be lined-up with the blade involving guesswork and trial-and-error cuts before exactly hitting the mark. A clear and precise point-of-cut at which a blade will sever a workpiece will also be herein referred to as a point-of-cut reference, or cutting-reference.

Porter Cable Corporation's 7700 model mitre saw incorporates within it's blade housing, a class 11 laser product. it is known by a trademark including an acronym for the words line-of-cut; i.e. LaserLOC™. This line-of-cut indicator visually delineates a clear and precise cutting reference to an operator. It allows that a cutting-mark on a workpiece can easily be lined up with the blade. Sufficient workpiece support throughout the cutting-area still is not addressed.

Most manufacturers of mitre saws, to include the above mentioned Porter Cable Corporation, provide through-holes disposed along a stock vertical back-fence(s) of their respective models. It is these through-holes through which an end-user bolts an auxiliary fence. It is common practice to in fact overlay the mitre saw body, covering it's horizontal base or table portion, and the upstanding vertical back-fence portion of a stock mitre saw. One crucial benefit in this is effectively closing the abovementioned overly large clearance gaps inherent in stock mitre saws. To this end, an auxiliary fence, generally L-shaped in cross-section is constructed of appropriate material, such as plywood, and is bolted to the mitre saw. Although limited and temporary, this practice offers the benefits of support for a workpiece, and provision of a clear and precise point-of-cut reference.

Mitre saws being of various sizes have respective limitations in maximum dimensions of a workpiece which they are capable of severing completely.

While a cut is being made, a blade guard makes travel-limiting contact with a top or uppermost surface of the workpiece. The blade guard is held at the height of the top of the workpiece even as the blade and blade housing continue their downward travel. A workpiece exceeding a maximum dimension in height will, at some point, cause the blade guard to ‘top-out’ within the blade housing, preventing further downward travel of the blade. The blade, now effectively ‘bottoms-out’, still within the overly high workpiece, which has been only partially cut-into. In this case, the workpiece sustains an arc-shaped blades-width partial kerf cut, yet remains otherwise structurally intact.

This effect can be utilized with an above mentioned auxiliary fence. A vertical back-fence portion constructed to a predetermined appropriate height, will cause the same travel-limiting contact such that the auxiliary fence itself, sustains only an arc-shaped partial kerf cut, even as a dimensionally appropriate workpiece is fully cut through. In this way, the auxiliary fence retains structural integrity and the partial kerf cut it now contains becomes an excellent cutting-reference as it delineates precisely where the blade will cut. In addition to this cutting-reference, support or back-up is lent to the workpiece at those critical above mentioned back and bottom surfaces. This back-up virtually eliminates abovementioned danger of shorter off-cuts being pulled by the blade, smashing-up within the blade housing and being uncontrollably thrown. Also, abovementioned undesirable effects of tear-out and chipping, are substantially prevented.

As has been previously mentioned however, these benefits are only temporary as they can be realized only at a singular degree of cutting-angle. In practice, the mitre saw is re-set for cutting at various angles within it's cutting range. As the blade imparts numerous partial kerf cuts, the mitre saw's cutting-range is effectively transferred to the auxiliary fence. As a result, the cutting-area of the auxiliary fence itself becomes enlarged, and effectively destroyed. The cutting-reference is lost, and material being cut is no longer backed-up. This causes further unnecessary danger as chunks of the auxiliary fence itself break-out, are pulled-in to smash-up within the body of the mitre saw, and are uncontrollably thrown. Eventually, it becomes necessary to replace the entire essentially useless auxiliary fence. This involves needless waste of material, time, and labor to construct and change-over an entire fresh auxiliary fence, the benefits of which again, will be only temporary.

Numerous examples exist confirming a need to effectively close or make small as possible, clearance gaps with relation to a power tool's cutting blade, or otherwise cutting element. Drawn from prior-art, a sampling of these examples will now be discussed.

Biesemeyer Manufacturing, Inc., known also by the trademark BIESEMEYER® offers in it's also trademarked T-Square® line of power tool accessories, precision-table-saw-inserts. These are, when purchased, blank or full inserts which fill the throat opening in the stock top working surface of a table saw. An end user, as the brochure recommends, acquires a supply of these inserts to accommodate cutting operations which utilize different blade dispositions, and different blades. This last, as table saw arbors accept both common generally ⅛″ thick and adjustably wider dadoe blades, along with incremental stacked-type dadoe blade sets. Use of what then become blade and angle-dedicated inserts, insures that a blade clearance gap is no larger than necessary for a particular blade or blade disposition.

The December 1994 Number 30 edition of Woodwork magazine, on p. 8, has an advertisement of a fence for router-tables and shapers. The fence itself is known by the trademark SMART FENCE PLUS™ and is covered by U.S. Pat. No. 5,018,562 issued to Adams on May 28, 1991. Not specifically mentioned in this patent, but shown in the abovementioned advertisement are inserts described as “ . . . removable profile inserts”. They are said to “ . . . create a zero-clearance fit to any cutter.” This leaves, as the advertisement states “ . . . no gap around the bit . . . ”, or cutter.

FIG. 6 of U.S. Pat. No. 5,301,726 to Wojcik issued on Apr. 12, 1994 depicts an embodiment of that disclosure adapted for use with router-tables and the like. More specifically, FIG. 6D of that embodiment discloses an aperture in it's fence into which a short workpiece could cant, and drop. In a way similar to abovementioned removable profile inserts of the SMART FENCE™ advertisement, Wojcik has therefore provided an insert to fill the aperture.

U.S. Pat. No. 5,325,900 issued Jul. 5, 1994 to Garuglieri and Brianza discloses a fence for power tools having a circular saw blade. Although they correctly recite a need to reduce an opening in such a fence to a narrow gap, their fence is not readily directed at mitre saws.

U.S. Pat. No. 5,016,693 issued May 21, 1991 to Haffely, Stahler, and Wixey discloses a guide fence for power tools. They, also recite a substantial need of a gap therein to be sized, generally as small as possible. They have substantially met this need as applicable mainly to power tools such as wood shapers and router-table arrangements while a need exists, still as applicable to mitre saws.

U.S. Pat. No. 4,452,117 issued Jun. 5, 1984 to Brickner, Rickmers, and Donovan discloses a self-adjusting fence for a motorized saw unit. They further disclose a pair of spaced and aligned vertical back-fence members, adjacent ends of which are kept in close proximity with a cutting channel. This cutting channel, disposed in a horizontal worktable portion of the saw unit, is a clearance gap. Providing clearance for the saw blade path has still resulted in gaps overly large relative to a generally ⅛″ thick blade.

U.S. Pat. No. 5,297,463 issued Mar. 29, 1994 to O'Banion and Meredith discloses an adjustable fence for a compound mitre saw. Although a portion of the vertical back-fence disclosed therein is versatile in it's positioning capability, the overall vertical back-fence is of two spaced-apart sections. Exposed there-between, is again, a clearance gap. This gap is large enough so as not to impart full support, or back-up to material being cut.

As a final example, U.S. Pat. No. 5,181,448 issued Jan. 26, 1993 to Terpstra discloses a mitre saw with adjustable workpiece supporting fence. In a way similar to abovementioned U.S. Pat. No. 5,297,463, there is again disclosed an adjustable portion of the vertical back-fence. Still, however, relatively large gaps are evident in providing clearance for the blade.

It is generally most desirable that, to the extent achievable virtual encasement of a workpiece is afforded throughout the abovementioned cutting-area of a particular powered cutting tool.

### OBJECTS AND ADVANTAGES

Accordingly, several objects and advantages of the present invention are:
(a) To provide full support for a workpiece throughout an entire cutting-area.
(b) To provide for virtual elimination of the hazard of shorter off-cuts being caught by a blade and uncontrollably thrown.
(c) To provide a precise and reusable cutting-reference for any angle, so as to delineate precisely where a blade will cut.
(d) To provide a precise and reusable cutting-reference, for any angle, used to quickly orient a workpiece so as to be cut to a desired length.
(e) To provide for virtual elimination of unwanted effects of tear-out and chipping of material being cut.
(f) To provide a single auxiliary fence system constructed of rigid and durable materials which need not be replaced for a substantially protracted period of time.
(g) To provide means whereby entire prior-art type auxiliary fences are no longer wastefully discarded, said means comprising said auxiliary fence system of the present invention.
(h) To provide, thereby, for conservation of material resource, time, and labor.
(i) To provide within a stationary fence-frame, an aperture the configuration of which overly encompasses a cutting-range.
(j) To provide a stationary fence-frame having an aperture the configuration of which allows that the stationary fence-frame is not cut-into.
(k) To provide multiple angle-dedicated inserts which together with the stationary fence-frame, comprise a cutting-system.
(l) To provide multiple angle-dedicated inserts the configuration of which overly encompass a cutting-range.
(m) To provide multiple angle-dedicated inserts which are easily removable, replacable, and reusable to selectively accommodate any degree of cutting-angle.
(n) To provide multiple angle-dedicated inserts which removably secure within an aperture of the stationary fence-frame.
(o) To provide for augmented levels of quality, ease, and speed of production for industrial settings and homeshop end-users.
(p) To provide means which effectively ‘close’ overly large clearance gaps in powered cutting tools, said means include elements of said cutting-system of the present invention.

Numerous variations and applications within the scope and spirit of the appended claims will be apparent to those skilled in the art in light of this disclosure.

### BRIEF DESCRIPTION OF DRAWING FIGURES

FIG. 1 is an exploded view according to the present invention.

FIG. 2 depicts a (prior-art) type auxiliary fence;

FIG. 2 (a) shows the fence of FIG. 2 having had its cutting-area destroyed.

FIG. 3 shows an exemplary 10″ mitre saw (prior-art).

FIG. 4 has the stationary fence-frame portion of the cutting system having been mounted on the mitre saw of FIG. 3.

FIG. 4 (a) has angle-dedicated insert in operative engagement with the fence-frame. A workpiece has been cut, leaving a shorter off-cut piece of material.

FIG. 5 shows a blade-guard portion of the mitre saw, with its blade-guard in travel-limiting contact with an uppermost edge of the angle-dedicated insert shown in FIG. 4(a).

FIG. 6 again shows the angle-dedicated insert with 90 degree cutting-reference taken alone for sectioning:

FIG. 6 (a) takes a section along the cutting reference,

FIG. 6 (b) is a reverse view showing the back, and bottom portions of this insert.

FIG. 7 is the fresh insert shown in FIG. 1. Its cutting-area is depicted as the area between arrows ‘AA’, and ‘BB’. FIG. 7(a) again shows the angle-dedicated insert with 90 degree cutting-reference 12(a)1 seen above. FIGS. 7(b) through 7(e) show other exemplary angle-dedicated inserts:

FIG. 7 (b) with cutting-reference for 31 degrees right, 12(b)2

FIG. 7 (c) “” 12 degrees left, 12(c)3

FIG. 7 (d) “” 47 degrees right, 12(d)4, and

FIG. 7 (e) “” 47 degrees left, 12(e)5.

### REFERENCE NUMERALS ON DRAWINGS

10 multiple insert fence system
11 stationary fence-frame
12 fresh insert,
   (a) angle-dedicated insert with 90 degree cutting-reference 12(a-1),
   (b) angle-dedicated insert with 31 degree right cutting-reference 12(b-2),
   (c) angle-dedicated insert with 12 degree left cutting-reference 12(c-3),
   (d) angle-dedicated insert with 47 degree right cutting-reference 12(d-4),
   (e) angle dedicated insert with 47 degree left cutting-reference 12(e-5)
13 (prior-art) type auxiliary fence,
   (a) its cutting area
   (b) throughholes with counterbores
14 workpiece,
   (a) top or uppermost surface,
   (b) back surface,
   (c) bottom surface,
15 cutting-mark on workpiece 14
16 shorter off-cut piece of material
17 exemplary 10″ mitre saw (prior-art)
18 horizontal base or table portion of mitre saw 17
19 rotatable disk of table portion 18,
   (a) blade clearance slot or gap,
   (b) outer edge,
   (c) degree of angle indicia (conventional, not shown)
20 upstanding, spaced-apart vertical back-fence sections of mitre saw 17,
   (a) blade clearance gap therebetween,
   (b) throughholes for bolt and nut arrangements,
   (c) bolt and nut arrangements (conventional, not shown),
   (d) top or uppermost edges
21 cutting-range of mitre saw 17
22 blade guard of mitre saw 17
23 circular cutting blade of mitre saw 17
24 blade housing of mitre saw 17
25 horizontal or bottom portion of fence-frame 11,
   (a) first working surface,
   (b) second surface or underside
26 arc-shaped ring or boundary of bottom portion 25
   (a) arc-shaped outer edge,
   (b) arc-shaped inner edge
27 transverse or angular edges of bottom portion 25
28 pocket, receptacle or aperture,
   (a) horizontal or bottom portion,
   (b) vertical or back portion
29 upstanding vertical back-fence sections of fence-frame 11,
   (a) first working surfaces,
   (b) second surfaces or rearward sides,
   (c) vertical edges
30 top or uppermost edges of back-fence 29
31 throughholes with counterbores (prior-art) disposed along back-fence 29
32 spring loaded ball-catches (prior-art) as supplemental securing means
33 horizontal or bottom portion of insert 12,
   (a) first working surface,
   (b) second surface or underside,
   (c) arc-shaped outer edge,
   (d) transverse or angular edges
34 upstanding vertical back-fence portion of insert 12,
   (a) first working surface,
   (b) second surface, back or rearward side,
   (c) top or uppermost edge,
   (d) enabling notch or depression,
   (e) vertical edges
35 initiating bevels,
   (a) recesses
36 cutting-area of insert 12

### CONCLUSION, RAMIFICATIONS, AND SCOPE OF INVENTION

It is therefore an object of the present invention to provide an auxiliary fence system which is itself not destroyed by the cutting operations for which it is used to enhance.

Accordingly, a preferred embodiment of the present invention includes:
(i) a rigid stationary fence-frame;
(ii) an aperture disposed within the stationary fence-frame and;
(iii) a plurality of angle-dedicated inserts, also rigid, each selectively of which removably secure within said aperture thereby accommodating various cutting-angles.

It is a further object to provide a cutting-system which while including continuous bi-planar surfaces, imparts full support to a workpiece across an entire cutting-area. It is this full support which virtually eliminates the hazard of shorter off-cuts of material being caught by a blade and uncontrollably thrown.

Still another advantage afforded by the cutting-system is a precise, quick, and reusable cutting-reference. This cutting-reference provides that an operator clearly sees precisely where the blade will cut.

Further, use of the cutting-system as described, provides for the virtual elimination of tear-out and chipping which occur as the blade exits a workpiece.

Also, material resource, time, and labor are conserved as entire prior-art type auxiliary fences would not now need to be replaced.

As those skilled in the art will perceive, various modifications of a cutting-system of the type herein described are possible. I will therefore briefly mention certain major aspects of a few.

In a table saw related embodiment the fence-frame element as described, would likely not be stationary and rather would include:
(i) runners disposed along an underside of the fence-frame member, which slidably associate with grooves or inverted T-slots disposed in a stock top, or working surface of the table saw, or;
(ii) an edge which movably associates with a stock guiding fence of the table saw.

In a radial arm saw related embodiment, elements as recited would likely be of larger configurational dimensions. Further, the elements would not necessarily associate with the radial arm saw in an overlay relationship, as the preferred embodiment relates to a mitre saw; rather the elements would comprise a table or working surface of the radial arm saw.

Similarly, a mitre saw related embodiment could include elements within the scope and spirit of the present invention, whereas these elements would be integral with a body of the mitre saw. As those skilled in the art will perceive, each of these exemplary cases will greatly benefit with effectively ‘closed’ clearance gaps.

In terms of securing means as described, minor, and largely insignificant departures may be made from the preferred embodiment. This last, as a snug fit results when elements as described are in operative association. It is therefore, the intent of this application along with the appended claims, to cover those variations as would become obvious to those skilled in the art, in light of this disclosure.

### STATIC DESCRIPTION OF PREFERRED EMBODIMENT

A preferred embodiment of the present invention will be herein described. It is intended to be exemplary and not limiting. It relates specifically to mitre saws and can easily be dimensionally adapted/modified for use with a variety of sizes and models of mitre saws available. By way of providing a single yet non-limiting set of approximate, exemplary dimensions, those relevant to a typical 10″ mitre saw will be herein recited.

Similarly, a variety of raw materials possess the appropriate rigidity and durability necessary for manufacture of such a system herein described. These would include: wood, plywood, composite wood products, plastics, composite plastics, metal, alloys, or any combination thereof.

Accordingly, by way of simplification and not limitation, the system will be herein described as being constructed of approximately ⅝″ thick baltic birch plywood, and utilizing common spring-loaded ball-catches which are of metal. Various thickness' of baltic birch plywood are widely available, and at least one supplier of such, is Firestone Plywood Corp. at 200 Miller Place, Hicksville, N.Y. 11801.

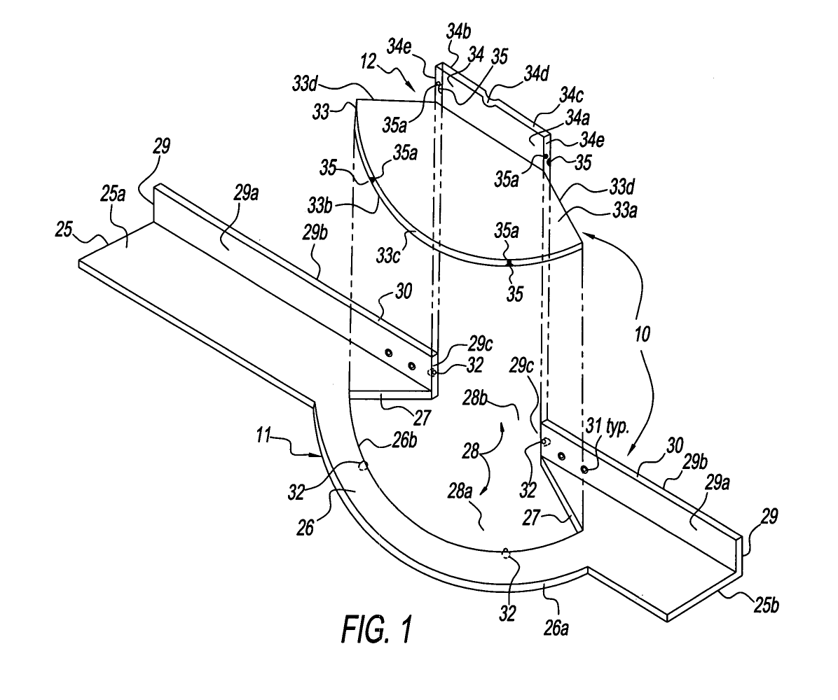

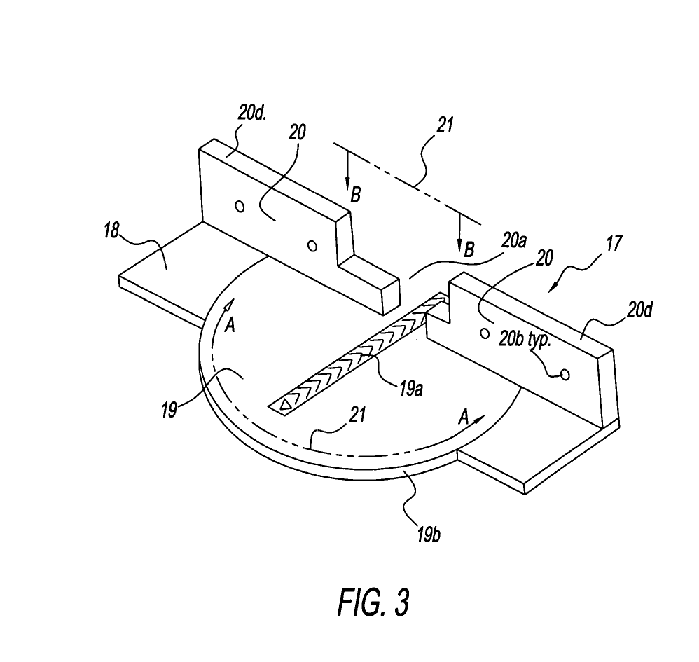

FIG. 1 is an exploded view according to the present invention. Elements of a multiple insert fence system 10 will now be described. A stationary fence-frame 11 extends longitudinally a distance at least sufficient to overlay elements of an exemplary 10″ mitre saw 17 (prior-art). Mitre saw 17 is shown in FIG. 3, and later to be more fully described.

Fence-frame 11 includes a horizontal, or bottom portion 25 fixedly communicating with upstanding vertical back-fence sections 29, in a substantially perpendicular relationship. This lends a generally L-shaped cross-section to fence-frame 11. Bottom portion 25 further includes a top, or first working surface 25a and an underside or second surface 25b. Also in evidence is an arc-shaped ring or boundary section 26 of bottom portion 25. In a direction toward an operator this boundary 26 outwardly terminates at an arc-shaped outer edge 26a. An arc-shaped inner edge 26b defines inner configurational parameters of boundary 26. Exposed, opposing, transverse, or angular edges 27 define configurational parameters of bottom-portion 25. Abovementioned back-fence sections 29 include faces or first working surfaces 29a, and second surfaces or rearward sides 29b. Back-fence sections 29 are spaced-apart exposing therebetween opposing vertical edges 29c. At an exemplary and approximate height of 4″, back-fence sections 29 upwardly terminate at their top or uppermost edges 30. Disposed along back-fence sections 29 is a plurality of throughholes with counterbores 31. These locationally correspond with stock throughholes for bolt and nut arrangements 20b disposed along upstanding, spaced-apart vertical back-fence sections 20 of mitre saw 17 (prior-art), shown in FIG. 3.

Included in the presently preferred embodiment is a plurality of spring loaded ball-catches 32 (prior-art). These are provided merely as supplemental securing means, and are disposed along abovementioned inner edge 26b of boundary 26, and vertical edges 29c of back-fence sections 29. Ball-catches 32 correspond locationally with initiating bevels 35, and associated recesses 35a. These are shown on fresh, blank or full insert 12.

Referring back to, and included within fence-frame 11, is a bi-planar pocket, receptacle or aperture 28. Aperture 28 includes a horizontal or bottom portion 28a, and a vertical or back portion 28b. Above-mentioned vertical edges 29c of back-fence sections 29 define lateral distal parameters of back portion 28b of aperture 28. Similarly, above-mentioned angular edges 27, and inner edge 26b, define configurational paramenters of bottom portion 28a of aperture 28.

Exemplary fresh insert 12 represents an original, not yet cut into condition of itself, and any of exemplary angle-dedicated insert(s) 12a through 12e. Being dimensionally and configurationally equivalent with aperture 28, insert 12 fully occupies aperture 28, when removably secured within fence-frame 11. There are then formed smooth, continuous bi-planar working surfaces.

Insert 12 includes a horizontal or bottom portion 33. This includes a top or first working surface 33a, and a second surface or underside 33b. Bottom portion 33 outwardly terminates at an arc-shaped outer edge 33c which meets, or engagingly associates with abovementioned inner edge 26b of boundary 26. Also, abovementioned initiating bevels 35, and recesses 35a are disposed along outeredge 33c. Transverse or angular edges 33d define lateral distal parameters of bottom portion 33, and engagingly associate with abovementioned angular edges 27 of bottom portion 25 of fence-frame 11.

Insert 12 further includes an upstanding vertical back-fence portion 34 which fixedly connects with bottom portion 33 in a substantially perpendicular relationship. As with abovementioned fence-frame 11, a generally L-shaped cross-section is thereby lent to insert 12. Included with back-fence portion 34 are a face or first working surface 34a and a second surface, back or rearward side 34b. Upwardly terminating at a top or uppermost edge 34c, back-fence portion 34 rises to an exemplary, and approximate height of 4″. This corresponds with abovementioned exemplary, and approximate height of back-fence sections 29 of fence-frame 11. At an approximate center of top edge 34c is provided an enabling notch 34d. Vertical edges 34e define lateral distal ends, or sides of vertical back-fence portion 34 of insert 12.

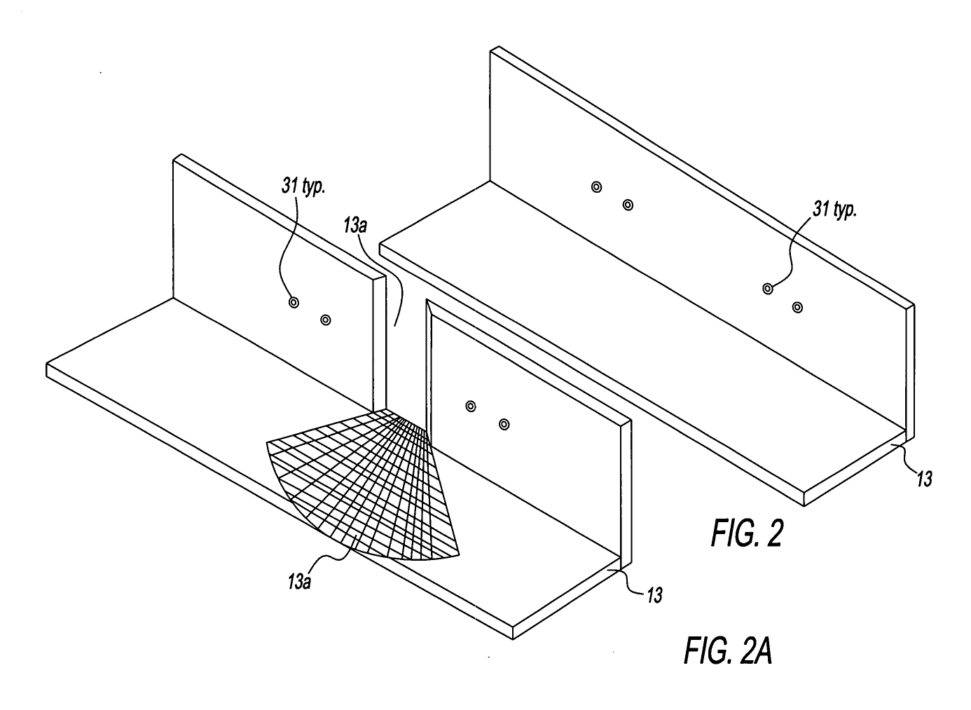

FIG. 2 depicts a fresh (not yet cut into) prior-art type auxiliary fence 13. FIG. 2a shows auxiliary fence 13 having had it's cutting-area 13a destroyed.

FIG. 3 shows a model-exemplary stock 10″ mitre saw 17 (prior-art). A table portion 18 contains a selectively rotatable disk 19 having, in relation to a generally ⅛″ thick blade, an overly wide blade clearance slot, or gap 19a. An arc-shaped outer edge 19b, defines the foremost terminal edge of rotatable disk 19. Degree of angle indicia 19c disposed in table portion 18, are conventional, and not shown. Upstanding, spaced-apart vertical back-fence sections 20, rise from table portion 18, in a substantially perpendicular relationship. In evidence, again, is an overly large blade clearance gap 20a therebetween. Through-holes 20b are disposed along back-fence sections 20.

These are for bolt and nut arrangements 20c which are conventional, and not shown. Uppermost or top edges 20d upwardly terminate back-fence sections 20. Depicted as the area within brackets ‘AA’, and ‘BB’, and in the horizontal, and vertical planes, are parameters of a cutting-range 21. Still referring to FIG. 3, and again to degree of angle indicia 19c, abovementioned cutting-range 21 is thereby indicated as infinitely inclusive of those angles from 47 degrees left of center or 90 degrees or 0 degrees of mitre, to 47 degrees right of center.

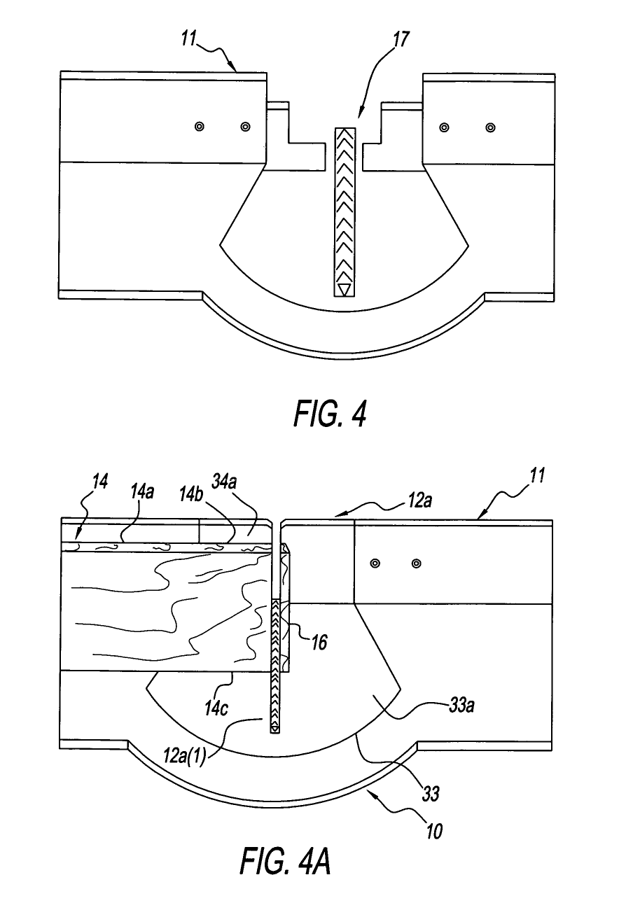

FIG. 4 has stationary fence-frame portion 11 having been mounted on mitre saw 17. FIG. 4a has angle-dedicated insert 12a engaged with fence-frame 11. Workpiece 14 has been cut to a desired length and left shorter off-cut 16. Off-cut 16 is intact and safely in place as it was fully supported and backed up by insert 12a. Cutting reference 12a(1) is also in evidence. Uppermost surface 14a is a top edge of workpiece 14. Back surface 14b of workpiece 14 is against first working surface 34. It is, thereby, fully supported and backed up. Bottom surface 14c of workpiece 14 too, is fully supported and backed up as it is against first working surface 33a of bottom portion 33 of insert 12a.

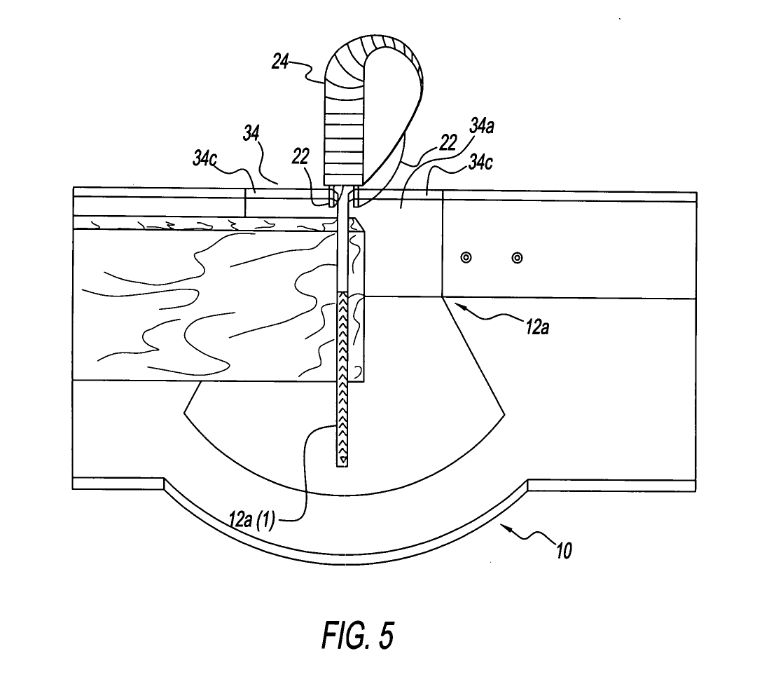

In FIG. 5 blade guard 22 is ‘topped-out’ within a blade housing 24 and is in travel-limiting contact with top or uppermost surface 34c of insert 12a. A cut has been made, and cutting-reference 12a(1) has resulted.

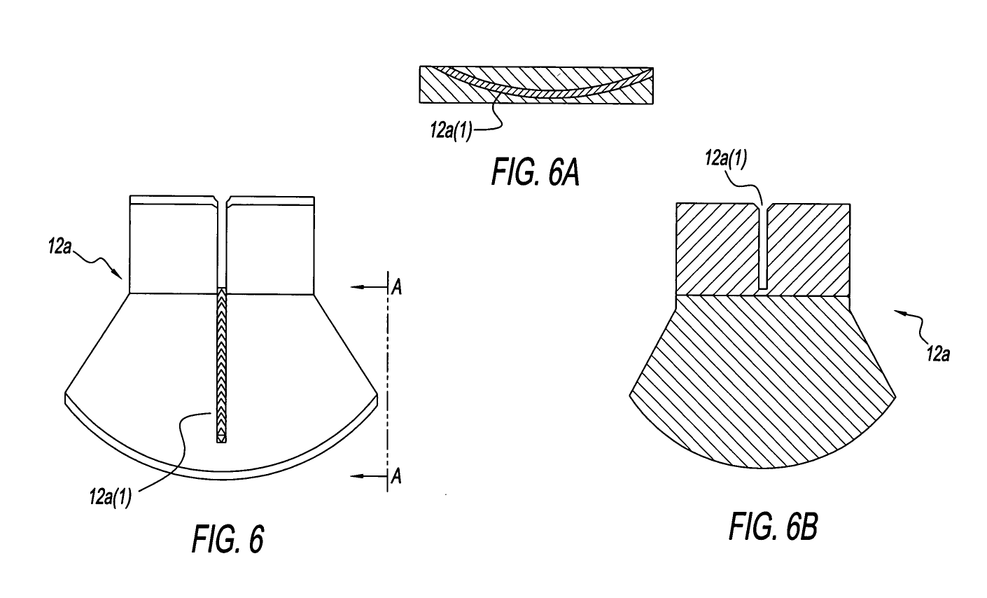

FIG. 6 shows exemplary angle-dedicated insert 12a having 90 degree cutting reference 12a (1). Section ‘AA’ taken across still intact bottom portion 33 shows cutting-reference 12a(1) also in FIG. 6a. FIG. 6b is a reverse view of insert 12a. It shows 90 degree cutting-reference 12a(1) in vertical back-fence portion 34 of insert 12a. As depicted, entire insert 12a remains intact.

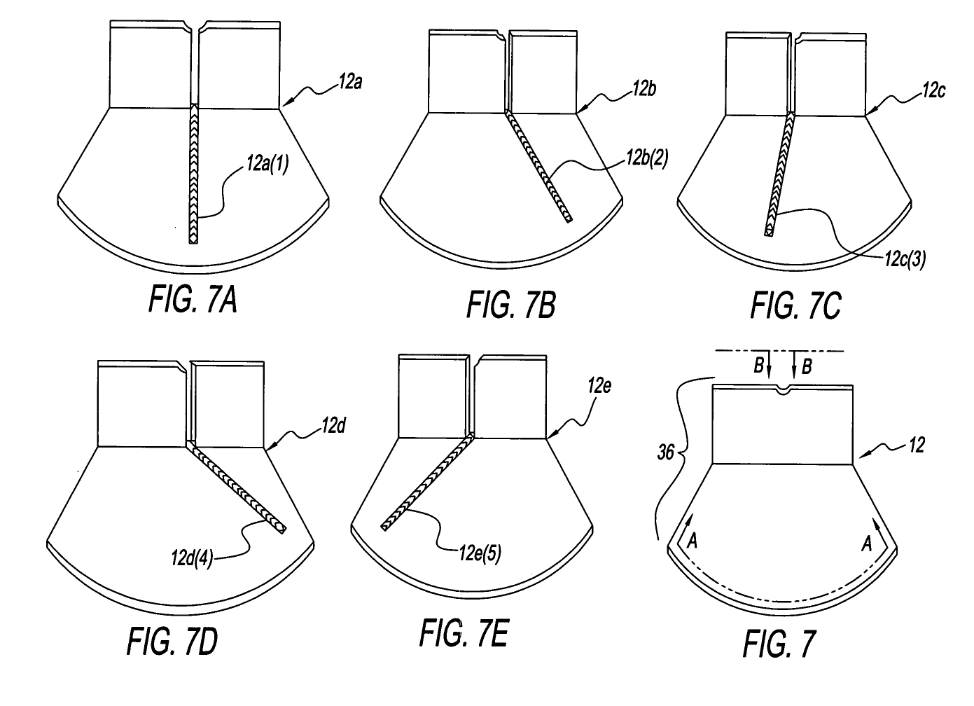

Fresh insert 12 of FIG. 1, is shown again in FIG. 7. A cutting-area 36 is depicted as between arrows ‘AA’, and ‘BB’. FIG. 7a again shows insert 12a of FIGS. 4a, 5, 6, 6a, and 6b. Cutting-reference 12a(1) also is shown again. FIG. 7b shows insert 12b with it's cutting-reference 12b(2). FIG. 7c shows insert 12c with it's cutting-reference 12c(3). FIG. 7d shows insert 12d with it's cutting-reference 12d(4). Lastly, FIG. 7e shows insert 12e with it's cutting-reference 12e(5).

### OPERATION DESCRIPTION OF PREFERRED EMBODIMENT

FIG. 1 shows multiple insert fence system 10 in exploded view. Fence-frame overlays mitre saw 17 as in FIG. 4 utilizing throughholes with counterbores 31, throughholes for bolt and nut arrangements 20b, seen in FIG. 3, and bolt and nut arrangements 20c, fence-frame 11 becomes operationally engaged with mitre saw 17.

Contiguous abutment results when exemplary fresh insert 12 is operatively engaged within aperture 28 of fence-frame 11. This conjunction meetingly associates inner edge 26b, with outeredge 33c, angular edges 27, with angular edges 33d, and vertical edges 29c, with vertical edges 34e. This conjunction too, effectively closes overly large clearance gaps 19a, and 20a shown in mitre saw 17 of FIG. 3. As will be appreciated through the interconnections thus far described, a snug fit results with insert 12 being operatively engaged within fence-frame 11. Still, supplemental securing means can be provided and are shown in FIG. 1. These include spring loaded ball-catches 32 (prior-art), initiating bevels 35, and recesses 35a. Initiating bevels 35 help facilitate the spring action in spring loaded ball-catches 32, and recesses 35a accept the actual ball. Disposed at an approximate center of uppermost edge 34c of insert 12 is enabling notch 34d. It allows for smooth passage past cutting blade 23 (conventional, not shown) while either operatively inserting or removing insert 12. Further, having insert 12 operatively engaged with fence-frame 11 continuous, smooth, bi-planar first working surfaces result and impart structural support to workpiece 14. These first surfaces are 25a, 33a, 29a, and 34a.

Still referring to FIG. 1 insert 12, when in operative engagement with fence-frame 11, fully occupies above mentioned aperture 28 throughout it's bottom portion 28a, and it's back portion 28b. This effectively closes overly large clearance gaps 19a, and 20a of mitre 17 seen in FIG. 3.

In operative engagement, boundary 26, and bottom portion 25 of fence-frame 11 overlay elements of table portion 18, and elements of rotatable disk 19, of mitre saw 17. Back-fence sections 29 of fence-frame 11 overlay elements of back-fence sections 20 of mitre saw 17. Bottom portion 33 of insert 12 overlays elements of rotatable disk 19 of mitre saw 17. Back-fence portion 34 of insert 12 overlays elements of back-fence sections 20 of mitre saw 17. Second surface or underside 25b of fence-frame 11 makes operative contact with elements of table portion 18, and rotatable disk 19 of mitre saw 17. Second surfaces or rearward sides 29b make operative contact with elements of back-fence sections 20 of mitre saw 17. Second surface or underside 33b of insert 12 makes operative contact with rotatable disk 19 of mitre saw 17. Likewise, second surface, back or rearward side 34b of insert 12 makes operative contact with elements of back-fence sections 20 of mitre saw 17. Arc-shaped outer edge 26a of boundary 26, and top or uppermost edges 30 of back-fence 29 are of sufficient thickness to impart rigidity to fence-frame 11. Likewise, abovementioned outeredge 33c, and uppermost edge 34c are of sufficient thickness to impart rigidity to insert 12.

FIG. 2 shows (prior-art) type auxiliary fence 13, throughholes with counterbores 13b are shown. FIG. 2a shows fence 13, after use, having had it's cutting-area 13a destroyed.

FIG. 4 shows fence-frame 11 in operative engagement with mitre saw 17.

FIG. 4a shows abovementioned multiple insert fence system 10 of the present invention. Exemplary insert 12a has been removably secured within fence-frame 11. Uppermost surface 14a is top edge of workpiece 14. Back surface 14b makes operative contact with first working surface 34a of back-fence portion 34 of insert 12a. Bottom surface 14c makes operative contact with first working surface 33a of bottom portion 33 of insert 12a.

Workpiece 14 has been completely severed to a desired length as the operator has a clear, precise, and reusable cutting-reference in cutting-reference 12a(1). Back surface 14b, and bottom surface 14c are intact, smooth, and cut cleanly as they are supported and backed up by insert 12a. Further, since it is backed up, shorter off-cut piece of material 16 remains safely in place.

FIG. 5 shows multiple insert fence system 10, also seen in FIG. 4a. Blade housing 24 of mitre saw 17 is also depicted. Blade guard 22 has topped-out within blade housing 24 as blade guard 22 is in travel-limiting contact with uppermost edge 34c of back-fence portion 34 of insert 12a. This contact causes circular cutting blade 23 (conventional, not shown) to bottom out still within insert 12a, which is only partially cut into. 90 degree cutting-reference 12a(1) results.

FIG. 6 shows insert 12a having sustained a blades width partial kerf cut yielding 90 degree cutting reference 12a(1). Section ‘AA’, taken from FIG. 6, and shown in FIG. 6a is a sideview showing 90 degree cutting reference 12a(1). Seen in this view it will be appreciated that while still intact, insert 12a has sustained an arc-shaped blades width partial kerf cut. FIG. 6b is a reverse view showing insert 12a still intact after sustaining the partial kerf cut which yields 90 degree cutting-reference 12a(1).

Each of exemplary inserts shown in FIGS. 7a through 7e have sustained a blades width partial kerf cut and are reusable with their respective cutting-references. A list follows:

insert 12a of FIG. 7a has 90 degree cutting-reference 12a(1),

insert 12b of FIG. 7b has 31 degree right cutting-reference 12b(2),

insert 12c of FIG. 7c has 12 degree left cutting-reference 12c(3),

insert 12d of FIG. 7d has 47 degree right cutting-reference 12d(4),

and insert 12e of FIG. 7e has 47 degree left cutting-reference 12e(5).

I claim:

1. A multiple insert fence system for a mitre saw includes continuous structural support means whereby material to be cut is fully backed up across a cutting area for any angle at which a mitre saw may be set to cut comprising:
(a) a stationary fence frame being generally L-shaped in cross-section,
(b) an aperture disposed within the fence frame,
(c) a plurality of angle-dedicated inserts, an original condition of each being fresh and not yet cut into,
(d) securing means to removably secure each selectively of said angle-dedicated inserts within said aperture of the fence frame.

2. Said multiple insert fence system of claim 1 wherein said continuous structural support means includes each selectively of said angle-dedicated inserts being operatively disposed within the aperture of the fence frame thereby creating continuous bi-planar first surfaces against which material to be cut is placed, those surfaces include a flat, horizontal base or bottom surface and a vertical back surface which together virtually eliminate:
(a) unwanted tear-out and chipping of a workpiece, and,
(b) the hazard of a shorter off-cut piece of material being caught by a blade, and uncontrollably thrown.

3. The multiple insert fence system of claim 1 wherein the fence-frame further comprises:
(a) a vertical back portion being generally parallel to a stock vertical back fence of a mitre saw and being in two sections disposed in a longitudinally spaced apart relationship exposing therebetween a gap defining a vertical back portion of said aperture,
(b) a longitudinally extending flat, horizontal base or bottom portion being generally parallel to a stock base or table of a mitre saw and which fixedly communicates with said vertical back portion of the fence-frame in a substantially 90 degree relationship,
(c) a bottom portion of the aperture being defined within the bottom portion of the fence-frame.

4. The multiple insert fence system of claim 1 wherein the fence-frame further comprises:
(a) said vertical back portion being in two sections of:
(i) a predetermined length extending longitudinally from either side of the aperture as to at least correspond with a length of a stock vertical back fence of a mitre saw,
(ii) a predetermined height somewhat exceeding the height of the thickest workpiece a particular mitre saw is meant to sever completely,
(iii) a thickness sufficient to impart the appropriate rigidity,
(b) the longitudinally extending bottom portion of:
(i) a predetermined length of at least corresponding with the length of a stock table of a mitre saw,
(ii) a depth and configuration whereby the bottom portion of the fence-frame is, at any point, beyond the cutting range of the mitre saw and,
(iii) a thickness sufficient to impart the appropriate rigidity,
(iiii) a generally L-shaped cross section as the back portion and the bottom portion fixedly communicate in a substantially perpendicular relationship.

5. The multiple insert fence system of claim 1 wherein each of the inserts further comprise:
(a) a vertical back portion and,
(b) a flat, horizontal bottom portion fixedly communicating with said vertical back portion in a substantially 90 degree relationship, and further include,
(c) a predetermined configuration whereby they extend somewhat beyond the cutting range of the mitre saw.

6. The multiple insert fence system of claim 1 wherein each of the inserts further comprise:
(a) a predetermined height somewhat exceeding the height of the thickest workpiece a particular mitre saw is meant to sever completely,
(b) a thickness sufficient to impart the appropriate rigidity,
(c) an overall configuration whereby the aperture is substantially occupied when any of the inserts is operatively disposed within the aperture of the fence frame.

7. The multiple insert fence system of claim 1 wherein each of the inserts further comprise:
(a) structural means to provide that travel-limiting contact occurs between a blade guard of the mitre saw and an uppermost edge of the back portion of any of the inserts includes:
(i) a predetermined height of the back portion of the insert, this height somewhat exceeds a height of the thickest workpiece a particular mitre saw is meant to sever completely, whereby,
(ii) the blade stops its downward travel imprinting a precise and reusable point of cut reference while the insert retains structural integrity, and the workpiece still, is severed completely.

8. The multiple insert fence system of claim 1 wherein each of the inserts further comprise:
(a) an enabling notch disposed along and generally centered on the uppermost edge of the back portion of the insert, which locationally corresponds with the blade of the mitre saw, and effectively lowers the height solely of a diminutive portion of the insert such that the insert may move freely past the blade without interference as it moves over the bottom portion of the fence frame for insertion within the fence frame, and removal therefrom.

9. The multiple insert fence system of claim 1 wherein the aperture includes a predetermined configuration whereby it extends somewhat beyond the cutting range of the mitre saw.

10. The multiple insert frame system of claim 1 wherein said precise and reusable point of cut reference means includes a blades width partial kerf cut sustained in any of the inserts.

11. The multiple insert fence system of claim 1 wherein the back fence of the fence frame further includes attachment means by which an end user operatively secures the fence frame to the vertical back fence of the mitre saw whereby the fence frame becomes operatively stationary, with said attachment means including through holes for for bolt and nut arrangements.

12. The multiple insert fence system of claim 1 wherein said securing means being disposed along edges defined by the aperture, and edges of the inserts, include securing means selected from a group consisting of but not limited to:
(a) one or more spring loaded ball catch mechanisms,
(b) some substantially equivalent device thereof,
(c) an arrangement of splines and grooves,
(d) magnets,
(e) a snug fit which results when any of the inserts is operatively engaged within the aperture of the fence frame, and
(f) some combination thereof.

13. The multiple insert fence system of claim 1 comprising industry appropriate material selected from but not limited to the following group:
(a) plywood,
(b) composite wood,
(c) composite plastic,
(d) metal,
(e) metal alloy,
(f) some combination thereof.

14. A multiple insert fence system which mounts on a mitre saw for providing precise and reusable point of cut reference means for any available cutting angle, comprising:
(a) a plurality of angle-dedicated inserts, which include appropriate rigidity,
(b) an appropriately rigid stationary fence frame,
(c) an aperture disposed within the fence frame and,
(d) securing means to removably secure each selectively of said angle-dedicated inserts within said aperture of the fence frame.

15. Said multiple insert fence system of claim 14 includes suitable dimensionality whereby a blade of a mitre saw imparts a partial kerf-cut which is sustained within the now, angle-dedicated insert such that the insert remains structurally intact, and which yields said precise and reusable point of cut reference means.

16. The multiple insert fence system of claim 14 includes continuous bi-planar structural support and back-up means for a workpiece somewhat beyond a cutting range of the mitre saw whereby:
(a) unwanted effects of tear-out and chipping of the workpiece are virtually eliminated and,
(b) a shorter off-cut piece of material remains positionally stable providing that the danger of its being caught by the blade, and uncontrollably thrown, too, is virtually eliminated.

17. An appropriately rigid auxiliary fence system for power cutting tools of the type having a circular cutting blade includes continuous bi-planar structural support means whereby material to be cut is fully backed up across a cutting area and precisely at a point of cut area for any angle, bevel, and operation said power cutting tool may be set to cut and perform, further comprising:
(a) a fence frame, and
(b) a plurality of removable and replaceable angle, bevel, and operation dedicated inserts.

18. The auxiliary fence system of claim 17 in a table saw related embodiment, would likely include elements from the following list:
(a) runners disposed along an underside of the fence frame which slidably associate with grooves disposed in a stock top, or working surface of the table saw, and
(b) an edge which movably associates with a stock guiding fence of the table saw.

19. The auxiliary fence system of claim 17, in a radial arm saw related embodiment, elements of the present invention would likely comprise a table or working surface of the radial arm saw.

20. The auxiliary fence system of claim 17, in a mitre saw related embodiment, could include elements within the scope and spirit of the present invention, whereas those elements would be integral with the body of the mitre saw.
